(19) United States
(12) Patent Application Publication
(10) Pub. No.: US 2005/0047374 A1
(43) Pub. Date: Mar. 3, 2005

(54) Method and system for providing a dynamic fade timer for use in a wireless network

(75) Inventors: Purva R. Rajkotia, Plano, TX (US); Anil K. Kandregula, Dallas, TX (US); Sanjaykumar Kodali, Dallas, TX (US); Vijayasimman Rajasimman, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/862,070

(22) Filed: Jun. 4, 2004

Related U.S. Application Data
(60) Provisional application No. 60/498,066, filed on Aug. 26, 2003.

(51) Int. Cl. H04Q 7/00

(52) U.S. Cl. 370/332; 370/328

(57) ABSTRACT

A method for providing a dynamic fade timer for use in a wireless network is provided that includes generating a timer message based on predetermined parameters and providing the timer message to a wireless communication device. The timer message includes fade timer information for the wireless communication device. The wireless communication device is operable to set a fade timer in the wireless communication device. The length of the fade timer is based on the fade timer information.

### CROSS-REFERENCE TO RELATED APPLICATIONS

The present invention is related to that disclosed in U.S. Provisional Patent Application Ser. No. 60/498,066, entitled “Dynamic Fade Timer,” filed on Aug. 26, 2003. Provisional Patent Application Ser. No. 60/498,066 is assigned to the assignee of the present application. The subject matter disclosed in Provisional Patent Application Ser. No. 60/498,066 is hereby incorporated by reference into the present disclosure as if fully set forth herein. The present invention hereby claims priority under 35 U.S.C. §119(e) to U.S. Provisional Patent Application Ser. No. 60/498,066.

### TECHNICAL FIELD OF THE INVENTION

The present invention is directed in general to wireless telecommunications networks and, more specifically, to a method and system for providing a dynamic fade timer for use in a wireless network.

### BACKGROUND OF THE INVENTION

In wireless telecommunication networks, the propagation conditions required for good quality signal communication between base stations and mobile stations cannot always be met due to the irregularities in cell coverage and rapid signal loss, e.g., due to the existence of areas that cannot be served by any base stations. This leads to call drops and ineffective resource utilization.

To decide when to drop a call, base stations and mobile stations typically have fade timers that are used to set an amount of time for which the base stations and mobile stations will wait while no good quality signals are being received before declaring a call failure and dropping the call. Conventional mobile stations generally have their fade timers programmed to 5 seconds, while conventional base stations generally have their fade timers programmed to 10 seconds.

Disadvantages associated with these conventional base stations and mobile stations include an inability to deal with different call conditions. For example, one sub-cell may have mountainous terrain with a road through a tunnel. A user of a mobile station may take more than 5 seconds to pass through the tunnel, and the signal in the tunnel may be so weak that it creates a hole in the sub-cell. In this situation, the call will be dropped as the user passes through the tunnel. Thus, the mobile station's 5-second fade timer is too short in this sub-cell. However, in another sub-cell with good coverage, the mobile station's 5-second fade timer may be too long, causing resources at the mobile station and the base station to be wasted while waiting for the fade timer to expire for a call that could have been dropped earlier.

### SUMMARY OF THE INVENTION

In accordance with the present invention, a method and system for providing a dynamic fade timer for use in a wireless network are provided that substantially eliminate or reduce disadvantages and problems associated with conventional methods and systems.

According to one embodiment of the present invention, a method for providing a dynamic fade timer for use in a wireless network is provided. The method includes generating a timer message based on predetermined parameters and providing the timer message to a wireless communication device. The timer message includes fade timer information for the wireless communication device. The wireless communication device is operable to set a fade timer in the wireless communication device. The length of the fade timer is based on the fade timer information.

According to another embodiment of the present invention, a wireless communication device is provided that includes a dynamic fade timer and a call monitor. The dynamic fade timer is operable to be set based on a timer message. The timer message includes fade timer information. The length of the dynamic fade timer is based on the fade timer information. The call monitor is operable to monitor a forward channel for frame quality for a plurality of frames received on the forward channel and to reset the dynamic fade timer based on the frame quality of the frames received on the forward channel.

According to yet another embodiment of the present invention, a base station is provided that includes a fade timer controller and a call monitor. The fade timer controller is operable to generate a timer message based on predetermined parameters and to provide the timer message to a wireless communication device. The timer message includes fade timer information for the wireless communication device. The wireless communication device is operable to set a first fade timer in the wireless communication device. The length of the first fade timer is based on the fade timer information. The call monitor is operable to monitor a reverse channel of a call for frame quality for a plurality of frames received on the reverse channel and to reset a second fade timer in the base station based on the frame quality of the frames received on the reverse channel.

According to still another embodiment of the present invention, a wireless network is provided that includes a plurality of base stations and a plurality of wireless communication devices. Each base station is operable to generate a timer message based on predetermined parameters. The timer message includes fade timer information. Each wireless communication device comprises a fade timer and is operable to receive the timer message from the base station. The length of the fade timer is based on the fade timer information.

Technical advantages of one or more embodiments of the present invention include providing a dynamic fade timer for use in a wireless network. In a particular embodiment, a wireless communication device has a fade timer whose length may be dynamically adjusted by a base station. As a result, the base station may take into account variations in one or more parameters, such as (i) environment, (ii) applications in use, (iii) location of the wireless communication device, (iv) previously received signals, (v) service options, and the like when determining the length of a fade timer for the wireless communication device. Accordingly, the fade timer may be lengthened or shortened as desired in order to reduce call drops and provide for more efficient resource utilization based on the selected parameters. In addition, for another embodiment, the base station also has a fade timer whose length may be dynamically adjusted based on the length of the fade timer for the wireless communication device.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior uses, as well as to future uses, of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 is a block diagram illustrating a general overview of a wireless network in which a dynamic fade timer may be used in accordance with one embodiment of the present invention;

FIG. 2 is a block diagram illustrating one of the base stations of FIG. 1 in greater detail in accordance with one embodiment of the present invention;

FIG. 3 is a block diagram illustrating one of the wireless communication devices of FIG. 1 in greater detail in accordance with one embodiment of the present invention;

FIG. 4 is a flow diagram illustrating a method for providing a dynamic fade timer for use in a base station in accordance with one embodiment of the present invention; and

FIG. 5 is a flow diagram illustrating a method for providing a dynamic fade timer for use in a wireless communication device in accordance with one embodiment of the present invention.

### DETAILED DESCRIPTION OF THE INVENTION

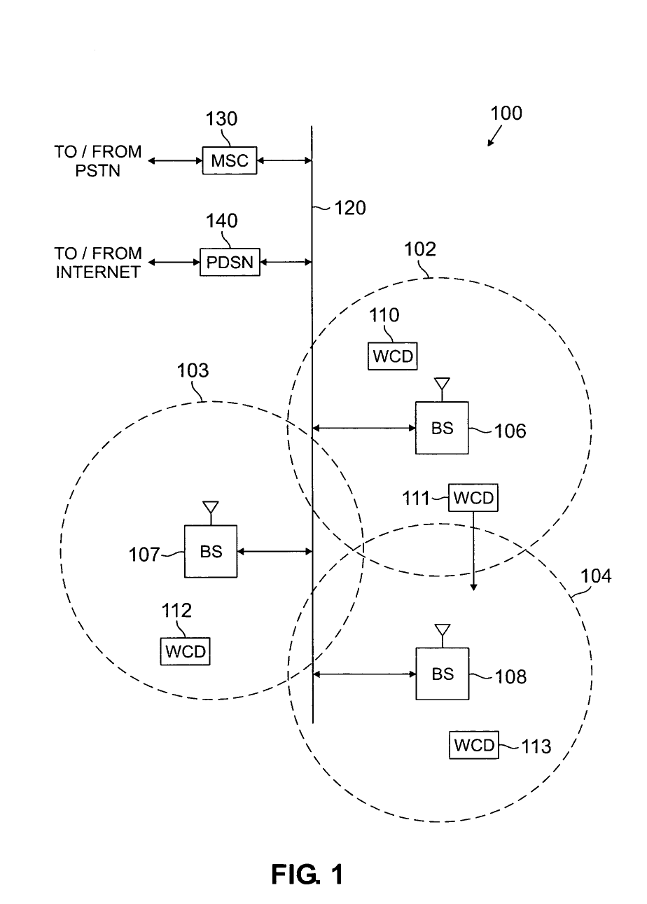

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 is a block diagram illustrating a general overview of a wireless network 100 in which a dynamic fade timer may be used in accordance with one embodiment of the present invention. The wireless network 100 comprises a plurality of cell sites 102-104, each of the cell sites 102-104 comprising a base station (BS) 106-108. As used herein, “each” means every one of at least a subset of the identified items.

Each base station 106-108 is operable to communicate with a plurality of wireless communication devices (WCD) 110-113. According to one embodiment, the base stations 106-108 are operable to communicate with the wireless communication devices 110-113 over code division multiple access (CDMA) channels according to the IS-2000-C standard (i.e., Release C of CDMA2000). Each of the wireless communication devices 110-113 may comprise a mobile wireless device, such as a cell phone, a PCS handset, a personal digital assistant (PDA) handset, a portable computer, a telemetry device, or the like, or any other suitable device operable to communicate with one of the base stations 106-108 via wireless links, including a stationary wireless device.

Dotted lines show the approximate boundaries of the cell sites 102-104 in which the base stations 106-108 are located. The cell sites 102-104 are shown approximately circular for the purposes of illustration and explanation only. It will be understood that the cell sites 102-104 may have other irregular shapes, depending on the cell configuration selected and natural and man-made obstructions.

The cell sites 102-104 comprise a plurality of sectors (not shown), where a directional antenna coupled to the base station 106-108 may provide service for each sector. The embodiment of FIG. 1 illustrates the base station 106-108 in the center of the cell site 102-104. In an alternate embodiment, the directional antennas may be positioned in corners of the sectors or in any other suitable location. The system of the present invention is not limited to any particular cell site configuration.

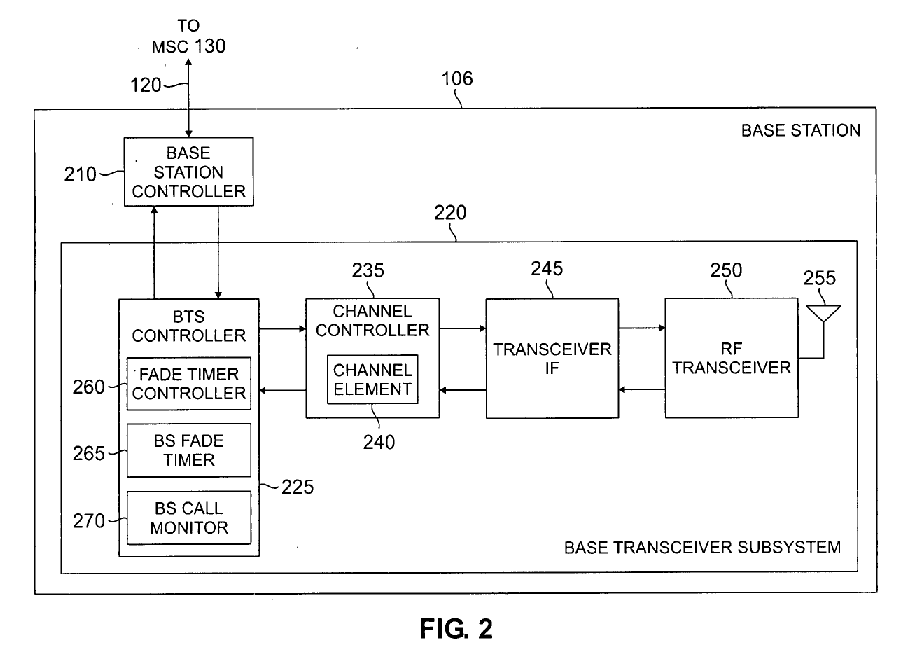

As described in more detail below in connection with FIG. 2, each base station 106-108 may comprise a base station controller and at least one base transceiver subsystem. The base station controllers are operable to manage wireless communications resources, including the base transceiver subsystems, for specified cells 102-104 within the wireless network 100. The base transceiver subsystems comprise the radiofrequency (RF) transceivers, antennas, and other electrical equipment located in each cell site 102-104. This equipment may include air conditioning units, heating units, electrical supplies, telephone line interfaces and radiofrequency transmitters and receivers. For the purpose of simplicity and clarity in explaining the operation of the present invention, the base transceiver subsystems in each of the cells 102, 103 and 104 and the base station controller associated with each base transceiver subsystem are collectively represented by the base station 106, the base station 107, and the base station 108, respectively.

The base stations 106-108 are operable to transfer voice and data signals between each other and the public switched telephone network (PSTN) (not shown) via communication line 120 and a mobile switching center (MSC) 130. The base stations 106-108 are also operable to transfer data signals, such as packet data, back and forth from the Internet (not shown) via communication line 120 and a packet data server node (PDSN) 140. Communication line 120 is also operable to establish connections for voice and data circuits between the MSC 130 and the base stations 106-108.

The communication line 120 may be any suitable connection means, including a T1 line, a T3 line, a fiber optic link, or any other type of data connection. The connections on line 120 may transmit analog voice signals or digital voice signals in pulse code modulated (PCM) format, Internet Protocol (IP) format, asynchronous transfer mode (ATM) format, or the like. According to one embodiment, line 120 also provides an IP connection that transfers data packets between the base stations 106-108 of the wireless network 100. Thus, line 120 may comprise a local area network that is operable to provide direct IP connections between base stations 106-108 without using the PDSN 140.

The MSC 130 comprises a switching device that is operable to provide services and coordination between the subscribers in the wireless network 100 and external networks, such as the PSTN or Internet. In some embodiments of the present invention, communications line 120 may be several different data links, where each data link couples one of the base stations 106-108 to the MSC 130.

In the embodiment of the wireless network 100 shown in FIG. 1, wireless communication device 110 and wireless communication device 111 are located in cell site 102 and are operable to communicate with base station 106. Wireless communication device 112 is located in cell site 103 and is operable to communicate with base station 107, and wireless communication device 113 is located in cell site 104 and is operable to communicate with base station 108.

The wireless communication device 111 is close to the edge of cell site 104. The direction arrow proximate to wireless communication device 111 indicates the movement of wireless communication device 111 towards cell site 104. At some point, as wireless communication device 111 moves into cell site 104 and out of cell site 102, a “handoff” will occur.

A handoff transfers control of a call from a first cell to a second cell. For example, if wireless communication device 111 is in communication with base station 106 and senses that the signal from base station 106 is becoming unacceptably weak, wireless communication device 111 may then switch to a base station that has a stronger signal, such as the signal transmitted by base station 108. Wireless communication device 111 and base station 108 establish a new communication link and a signal is sent to base station 106 and the public switched telephone network to transfer the on-going voice, data, or control signals through base station 108. The call is thereby seamlessly transferred from base station 106 to base station 108. An “idle” handoff is a handoff between cells of a wireless communication device 110-113 that is communicating in the control or paging channel, rather than transmitting voice and/or data signals in the regular traffic channels.

As described in more detail below, in accordance with the present invention, the base stations 106-108 are operable to dynamically adjust the length of the fade timers in the wireless communication devices 110-113. In selecting the length of a fade timer for a wireless communication device 110-113, the base stations 106-108 may take into account variations in one or more parameters, such as (i) environment, (ii) applications in use, (iii) location of the wireless communication device, (iv) previously received signals, (v) service options, and the like. Thus, the fade timers may be lengthened or shortened as desired in order to reduce call drops and provide for more efficient resource utilization based on the selected parameters.

In accordance with another embodiment of the present invention, the base stations 106-108 may also be operable to dynamically adjust the length of their own fade timers. For this embodiment, each base station 106-108 may select the length of its fade timer based on the length of the fade timers for the wireless communication devices 110-113 with which the base station 106-108 is communicating. For example, the length of the base station fade timer may be selected to be a specific multiple of the length of the wireless communication device fade timer, such as twice or any other suitable multiple of the length, or to be a specific amount of time longer that the length of the wireless communication device fade timer, such as two, three, five or any other suitable number of seconds longer.

FIG. 2 is a block diagram illustrating one of the base stations 106-108 in greater detail in accordance with one embodiment of the present invention. The base station 106 is illustrated as an example. However, it will be understood that the components illustrated and described with respect to the base station 106 are also part of the base stations 107 and 108.

The base station 106 comprises a base station controller 210 and at least one base transceiver subsystem 220, as previously described in connection with FIG. 1. The base station controller 210 is operable to manage the resources in cell site 102, including the base transceiver subsystem 220. According to one embodiment, the base transceiver subsystem 220 comprises a base transceiver subsystem (BTS) controller 225, a channel controller 235 (which may comprise at least one channel element 240), a transceiver interface (IF) 245, a radiofrequency (RF) transceiver unit 250, and an antenna array 255.

The BTS controller 225 may comprise processing circuitry and memory capable of executing an operating program that controls the overall operation of the base transceiver subsystem 220 and communicates with the base station controller 210. Under normal conditions, the BTS controller 225 directs the operation of channel controller 235, which may comprise a number of channel elements, such as channel element 240, that are each operable to perform bidirectional communication in the forward channel and the reverse channel. A “forward channel” refers to outbound signals from the base station 106 to a wireless communication device 110-111 and a “reverse channel” refers to inbound signals from a wireless communication device 110-111 to the base station 106. The transceiver IF 245 is operable to transfer the bidirectional channel signals between the channel controller 235 and the RF transceiver unit 250.

The BTS controller 225 also comprises a fade timer controller 260, a base station (BS) fade timer 265, and a BS call monitor 270. The fade timer controller 260 is operable to select varying lengths for fade timers in wireless communication devices 110-111 with which the base transceiver subsystem 220 is communicating in order to dynamically adjust the lengths of the fade timers. In selecting the length of a fade timer for a wireless communication device 110-111, the fade timer controller 260 may take into account variations in one or more parameters, such as (i) environment, (ii) applications in use, (iii) location of the wireless communication device, (iv) previously received signals, (v) service options, and the like.

The fade timer controller 260 is also operable to generate a timer message that comprises fade timer information for the wireless communication devices 110-111 in order to notify the wireless communication devices 110-111 of the lengths of their fade timers. The timer message may comprise an extended channel assignment message (ECAM), universal handoff direction message (UHDM), extended system parameter message (ESPM), origination message, page response message, parameter message or any other suitable message provided by the base station 106 to the wireless communication devices 110-111. Thus, for this embodiment, the fade timer controller 260 is operable to generate the timer message by incorporating the fade timer information into another suitable message. However, it will be understood that the timer message may comprise a unique message that includes only the fade timer information and not any additional information for the wireless communication device 110-111.

In accordance with one embodiment of the present invention, the fade timer controller 260 may also be operable to select varying lengths for the BS fade timer 265 in order to dynamically adjust the length of the BS fade timer 265. The fade timer controller 260 may select the length of the BS fade timer 265 based on the length of the fade timers for the wireless communication devices 110-111 with which the base transceiver subsystem 220 is communicating. For example, the length of the BS fade timer 265 may be selected to be a specific multiple of the length of the wireless communication device fade timer, such as twice or any other suitable multiple of the length, or to be a specific amount of time longer that the length of the wireless communication device fade timer, such as two, three, five or any other suitable number of seconds longer. Thus, the BS fade timer 265 may be static and set to be a predefined length or may be dynamic and set to be a varying length based on predefined parameters.

The BS call monitor 270 is operable to monitor frames received from the wireless communication devices 110-111 at the base transceiver subsystem 220 on the reverse channel. When the frames are of good quality, the BS call monitor 270 is operable to reset the BS fade timer 265. However, when a specified number, such as two or any other suitable number, of frames are not of good quality, the BS call monitor 270 is operable to disable the transmission of frames from the base transceiver subsystem 220 and continue monitoring the reverse channel until the BS fade timer 265 has expired or until frames of good quality begin to be received. If the BS fade timer 265 expires before any frames of good quality are received, the BTS controller 225 is operable to release the call.

For call handoffs according to one embodiment, the fade timer controller 265 of the target base station 106-108 (or base transceiver subsystem 220) may select an updated length for the fade timer for a wireless communication device 110-113 moving from one cell to another or from one sub-cell to another. The target base station 106-108 may then notify the source base station 106-108 (or base transceiver subsystem 220) of the updated fade timer length, and the source base station 106-108 may notify the wireless communication device 110-113 of the updated fade timer length. Thus, when the wireless communication device 110-113 is completing the handoff procedure to the target base station 106-108 and after the handoff procedure is finished, the wireless communication device 110-113 uses the updated fade timer length that corresponds to the target base station 106-108.

The antenna array 255 is operable to transmit forward channel signals received from the RF transceiver unit 250 to wireless communication devices 110-111 in the coverage area of the base station 106. The antenna array 255 is also operable to send to the RF transceiver unit 250 reverse channel signals received from wireless communication devices 110-111 in the coverage area of the base station 106. According to one embodiment of the present invention, the antenna array 255 comprises a multi-sector antenna, such as a three-sector antenna in which each antenna sector is responsible for transmitting and receiving in a coverage area corresponding to an arc of approximately 120°. Additionally, the RF transceiver unit 250 may comprise an antenna selection unit to select among different antennas in the antenna array 255 during both transmit and receive operations.

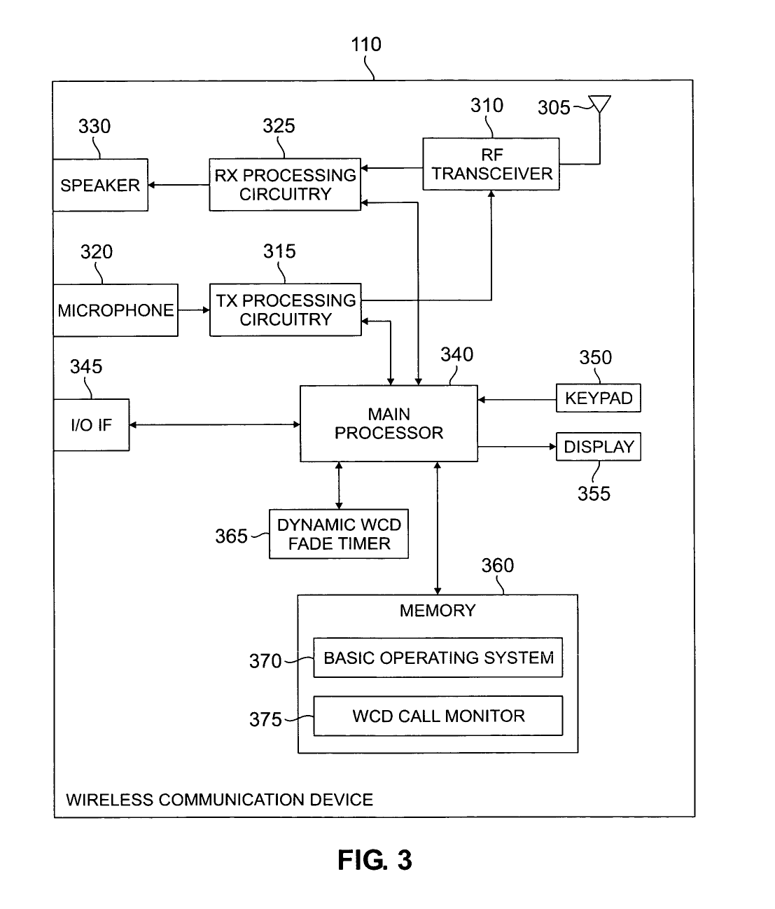

FIG. 3 is a block diagram illustrating one of the wireless communication devices 110-113 in greater detail in accordance with one embodiment of the present invention. The wireless communication device 110 is illustrated as an example. However, it will be understood that the components illustrated and described with respect to the wireless communication device 110 are also part of the wireless communication devices 111-113.

The wireless communication device 110 comprises an antenna 305, a radiofrequency (RF) transceiver 310, transmit (TX) processing circuitry 315, a microphone 320, receive (RX) processing circuitry 325, and a speaker 330. The wireless communication device 110 also comprises a main processor 340, an input/output (I/O) interface (IF) 345, a keypad 350, a display 355, a memory 360, and a dynamic wireless communication device (WCD) fade timer 365.

The RF transceiver 310 is operable to receive from the antenna 305 an incoming RF signal transmitted by one of the base stations 106-108 of the wireless network 100. The RF transceiver 310 is also operable to down-convert the incoming RF signal to produce an intermediate frequency (IF) or a baseband signal. The IF or baseband signal may be sent to the receiver processing circuitry 325, which is operable to produce a processed baseband signal by filtering, decoding and/or digitizing the baseband or IF signal. The receiver processing circuitry 325 is also operable to transmit the processed baseband signal to the speaker 330 (e.g., when the processed baseband signal comprises voice data) or to the main processor 340 for further processing (e.g., when the processed baseband signal relates to web browsing).

The transmitter processing circuitry 315 is operable to receive analog or digital voice data from the microphone 320 or other outgoing baseband data (e.g., web data, e-mail, interactive video game data and the like) from the main processor 340. The transmitter processing circuitry 315 is also operable to encode, multiplex and/or digitize the outgoing baseband data to produce a processed baseband or IF signal. The RF transceiver 310 is operable to receive the outgoing processed baseband or IF signal from the transmitter processing circuitry 315. The RF transceiver 310 is also operable to up-convert the baseband or IF signal to a radiofrequency signal that may be transmitted via the antenna 305.

According to one embodiment, the main processor 340 comprises a microprocessor or microcontroller. The memory 360, which is coupled to the main processor 340, may comprise a random access memory (RAM) and/or a read-only memory (ROM).

The main processor 340 is operable to execute a basic operating system program 370 stored in the memory 360 in order to control the overall operation of the wireless communication device 110. In one such operation, the main processor 340 controls the reception of forward channel signals and the transmission of reverse channel signals by the RF transceiver 310, the receiver processing circuitry 325, and the transmitter processing circuitry 315. The main processor 340 is also operable to execute other processes and programs resident in the memory 360. The main processor 340 may move data into or out of the memory 360, as required by an executing process.

The main processor 340 is also coupled to the I/O interface 345. The I/O interface 345 is operable to provide the wireless communication device 110 with the ability to connect to other devices, such as laptop computers, handheld computers and the like. The I/O interface 345 provides a communication path between these accessories and the main controller 340.

The main processor 340 is also coupled to the keypad 350 and the display unit 355. The operator of the wireless communication device 110 may use the keypad 350 to enter data into the wireless communication device 110. The display 355 may comprise a liquid crystal display capable of rendering text and/or graphics from websites. It will be understood that additional embodiments may use other types of displays.

The main processor 340 is also coupled to the dynamic WCD fade timer 365. The dynamic WCD fade timer 365 is operable to be dynamically adjusted such that the length of the WCD fade timer 365 may vary. According to one embodiment, the length of the WCD fade timer 365 may be determined by the fade timer controller 260 of the base station 106-108 and provided to the wireless communication device 110 through a timer message, as described above in connection with FIG. 2.

The memory 360 may also comprise a WCD call monitor 375 that is operable to monitor frames received from the base station 106-108 on the forward channel. When the frames are of good quality, the WCD call monitor 375 is operable to reset the WCD fade timer 365. However, when a specified number, such as two or any other suitable number, of frames are not of good quality, the WCD call monitor 375 is operable to disable the transmission of frames from the wireless communication device 110 and continue monitoring the forward channel until the WCD fade timer 365 has expired or until frames of good quality begin to be received. If the WCD fade timer 365 expires before any frames of good quality are received, the wireless communication device 110 is operable to release the call.

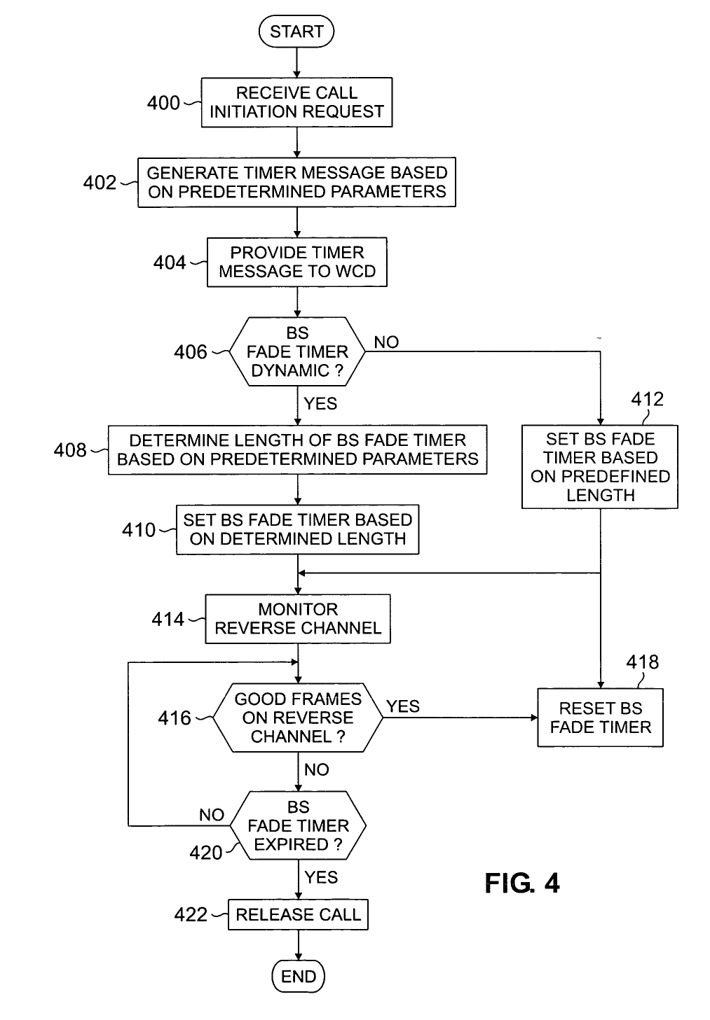

FIG. 4 is a flow diagram illustrating a method for providing a dynamic fade timer for use in the wireless network 100 from the perspective of one of the base stations 106-108 in accordance with one embodiment of the present invention. For simplicity, the base station 106 and the wireless communication device 110 are described as an example. However, it will be understood that the following method may also be implemented in any of the base stations 107-108 and in any of the wireless communication devices 111-113.

The method begins at step 400 where a base station 106 receives a call initiation request from a wireless communication device 110. At step 402, the base station 106 generates a timer message based on predetermined parameters for the wireless communication device 110. The timer message comprises fade timer information, including the length of the fade timer, for the WCD fade timer 365. The predetermined parameters may comprise (i) environment, (ii) applications in use, (iii) location of the wireless communication device, (iv) previously received signals, (v) service options and/or any other suitable parameters.

For one embodiment, the timer message comprises an ECAM, UHDM, ESPM, origination message, page response message, parameter message or any other suitable message provided by the base station 106 to the wireless communication device 110. Thus, for this embodiment, the base station 106 generates the timer message by incorporating the fade timer information into another suitable message. However, it will be understood that the timer message may comprise a unique message that includes only the fade timer information and not any additional information for the wireless communication device 110. In addition, for one embodiment, the fade timer controller 260 may generate the timer message.

At step 404, the base station 106 provides the timer message to the wireless communication device (WCD) 110. According to one embodiment, the fade timer controller 260 provides the timer message to the wireless communication device 110.

At decisional step 406, a determination is made regarding whether or not the BS fade timer 265 is dynamic. If the BS fade timer 265 is dynamic, the method follows the Yes branch from decisional step 406 to step 408. At step 408, the base station 106 determines the length of the BS fade timer 265 based on predetermined parameters. The predetermined parameters may comprise a specific multiple of the length of the WCD fade timer 365, such as twice or any other suitable multiple of the length, a specific amount of time longer that the length of the WCD fade timer 365, such as two, three, five or any other suitable number of seconds longer, or any other suitable parameter. According to one embodiment, the fade timer controller 260 determines the length of the BS fade timer 265. At step 410, the base station 106 sets the BS fade timer 265 based on the length determined in step 408.

Returning to decisional step 406, if the BS fade timer 265 is not dynamic, the method follows the No branch from decisional step 406 to step 412. At step 412, the base station 106 sets the BS fade timer 265 based on a predefined length, such as 10 seconds or any other suitable amount of time. From steps 410 and 412, the method continues to step 414.

At step 414, the base station 106 monitors the reverse channel for frame quality. According to one embodiment, the BS call monitor 270 monitors the reverse channel. At decisional step 416, a determination is made regarding whether or not a specified number of the frames received most recently on the reverse channel are of good quality. The specified number of frames may comprise two or any other suitable number. If the specified number of frames received most recently on the reverse channel are of good quality, the method follows the Yes branch from decisional step 416 to step 418.

At step 418, the base station 106 resets the BS fade timer 265, after which the method returns to step 414 where the base station 106 continues to monitor the reverse channel. According to one embodiment, the BS call monitor 270 resets the BS fade timer 265.

Returning to decisional step 416, if the specified number of frames received most recently on the reverse channel are not of good quality, the method follows the No branch from decisional step 416 to decisional step 420.

At decisional step 420, a determination is made regarding whether or not the BS fade timer 265 has expired. If the BS fade timer 265 has not expired, the method follows the No branch from decisional step 420 and returns to decisional step 416 where another determination is made regarding whether or not the specified number of frames received most recently on the reverse channel are of good quality.

However, if the BS fade timer 265 has expired, the method follows the Yes branch from decisional step 420 to step 422. At step 422, the base station 106 releases the call, at which point the method comes to an end.

In this way, the base station 106 may dynamically adjust the WCD fade timer 365 and, for one embodiment, the BS fade timer 265. The length of the WCD fade timer 365 may be selected based on variations in one or more parameters, such as (i) environment, (ii) applications in use, (iii) location of the wireless communication device, (iv) previously received signals, (v) service options, and the like. Therefore, the WCD fade timer 365, and possibly the BS fade timer 265, may be lengthened or shortened as desired in order to reduce call drops and provide for more efficient resource utilization based on the selected parameters.

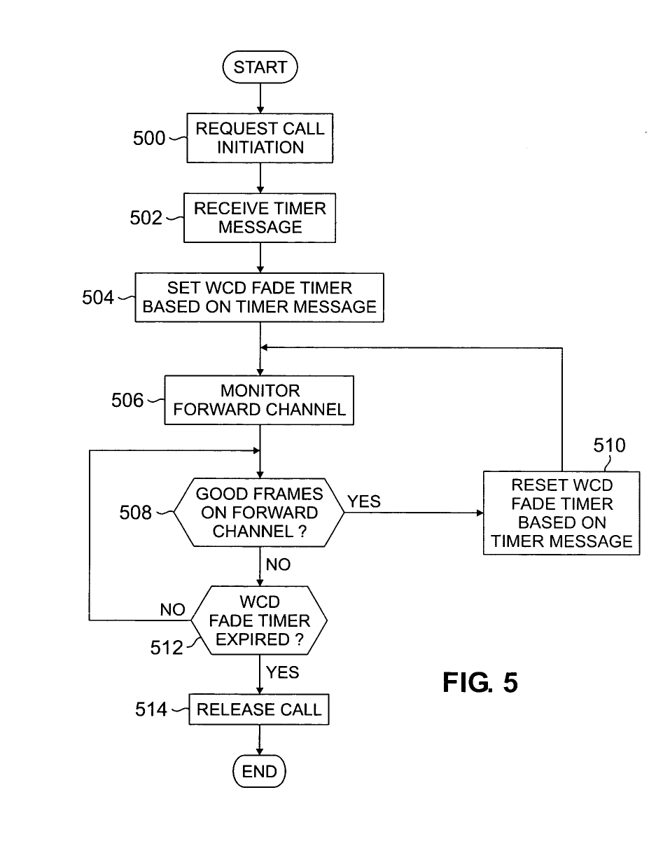

FIG. 5 is a flow diagram illustrating a method for providing a dynamic fade timer for use in the wireless network 100 from the perspective of one of the wireless communication devices 110-113 in accordance with one embodiment of the present invention. For simplicity, the base station 106 and the wireless communication device 110 are described as an example. However, it will be understood that the following method may also be implemented in any of the base stations 107-108 and in any of the wireless communication devices 111-113.

The method begins at step 500 where a wireless communication device 110 requests that a base station 106 initiate a call for the wireless communication device 110. At step 502, the wireless communication device 110 receives a timer message from the base station 106. The timer message comprises fade timer information, including the length of the fade timer, for the WCD fade timer 365. The length of the WCD fade timer 365 may be based on variations in predetermined parameters such as (i) environment, (ii) applications in use, (iii) location of the wireless communication device, (iv) previously received signals, (v) service options and/or any other suitable parameters.

For one embodiment, the timer message comprises an ECAM, UHDM, ESPM, origination message, page response message, parameter message or any other suitable message provided by the base station 106 to the wireless communication device 110. However, it will be understood that the timer message may comprise a unique message that includes only the fade timer information and not any additional information for the wireless communication device 110.

At step 504, the wireless communication device 110 sets the WCD fade timer 365 based on the length provided in the timer message. At step 506, the wireless communication device 110 monitors the forward channel for frame quality. According to one embodiment, the WCD call monitor 375 monitors the forward channel.

At decisional step 508, a determination is made regarding whether or not a specified number of the frames received most recently on the forward channel are of good quality. The specified number of frames may comprise two or any other suitable number. If the specified number of frames received most recently on the forward channel are of good quality, the method follows the Yes branch from decisional step 508 to step 510.

At step 510, the wireless communication device 110 resets the WCD fade timer 365 based on the length provided in the timer message, after which the method returns to step 506 where the wireless communication device 110 continues to monitor the forward channel. According to one embodiment, the WCD call monitor 375 resets the WCD fade timer 365.

Returning to decisional step 508, if the specified number of frames received most recently on the forward channel are not of good quality, the method follows the No branch from decisional step 508 to decisional step 512.

At decisional step 512, a determination is made regarding whether or not the WCD fade timer 365 has expired. If the WCD fade timer 365 has not expired, the method follows the No branch from decisional step 512 and returns to decisional step 508 where another determination is made regarding whether or not the specified number of frames received most recently on the forward channel are of good quality.

However, if the WCD fade timer 365 has expired, the method follows the Yes branch from decisional step 512 to step 514. At step 514, the wireless communication device 110 releases the call, at which point the method comes to an end.

In this way, the WCD fade timer 365 may be dynamically adjusted based on variations in one or more parameters, such as (i) environment, (ii) applications in use, (iii) location of the wireless communication device, (iv) previously received signals, (v) service options, and the like. Therefore, the WCD fade timer 365 may be lengthened or shortened as desired in order to reduce call drops and provide for more efficient resource utilization based on the selected parameters.

Although the present invention has been described with several embodiments, various changes and modifications may be suggested to one skilled in the art. It is intended that the present invention encompass such changes and modifications as fall within the scope of the appended claims.

1. A method for providing a dynamic fade timer for use in a wireless network, comprising:
generating a timer message based on predetermined parameters, the timer message comprising fade timer information for a wireless communication device, the wireless communication device operable to set a fade timer in the wireless communication device, the length of the fade timer based on the fade timer information; and
providing the timer message to the wireless communication device.

2. The method of claim 1, the predetermined parameters comprising one or more of (i) environment, (ii) applications in use, (iii) location of the wireless communication device, (iv) previously received signals, and (v) service options.

3. The method of claim 1, the timer message comprising one of an extended channel assignment message, a universal handoff direction message, an extended system parameter message, an origination message, a page response message, and a parameter message.

4. The method of claim 1, further comprising receiving a call initiation request from the wireless communication device, generating a timer message comprising generating the timer message based on receiving the call initiation request.

5. The method of claim 1, the fade timer in the wireless communication device comprising a first fade timer, the method further comprising:
determining a length for a second fade timer in a base station based on predetermined parameters for the second fade timer; and
setting the second fade timer based on the determined length.

6. The method of claim 5, the predetermined parameters for the second fade timer comprising a specific multiple of the length of the first fade timer.

7. The method of claim 6, the specific multiple comprising two.

8. The method of claim 5, the predetermined parameters for the second fade timer comprising a specific amount of time longer that the length of the first fade timer.

9. The method of claim 5, further comprising:
monitoring a reverse channel of a call for frame quality for a plurality of frames received on the reverse channel;
determining whether a specified number of the frames received most recently on the reverse channel are of good quality;
resetting the second fade timer when the specified number of the frames received most recently on the reverse channel are of good quality;
determining whether the second fade timer has expired when the specified number of the frames received most recently on the reverse channel are not of good quality; and
releasing the call when the second fade timer has expired.

10. The method of claim 9, the specified number of frames comprising two.

11. A wireless communication device, comprising:
a dynamic fade timer operable to be set based on a timer message, the timer message comprising fade timer information, the length of the dynamic fade timer based on the fade timer information; and
a call monitor operable to monitor a forward channel of a call for frame quality for a plurality of frames received on the forward channel and to reset the dynamic fade timer based on the frame quality of the frames received on the forward channel.

12. The wireless communication device of claim 11, the timer message generated based on predetermined parameters.

13. The wireless communication device of claim 12, the predetermined parameters comprising one or more of (i) environment, (ii) applications in use, (iii) location of the wireless communication device, (iv) previously received signals, and (v) service options.

14. The wireless communication device of claim 11, the timer message comprising one of an extended channel assignment message, a universal handoff direction message, an extended system parameter message, an origination message, a page response message, and a parameter message.

15. The wireless communication device of claim 11, the call monitor further operable (i) to determine whether a specified number of the frames received most recently on the forward channel are of good quality, (ii) to reset the dynamic fade timer when the specified number of the frames received most recently on the forward channel are of good quality, (iii) to determine whether the dynamic fade timer has expired when the specified number of the frames received most recently on the forward channel are not of good quality, and (iv) to release the call when the dynamic fade timer has expired.

16. A base station, comprising:
a fade timer controller operable to generate a timer message based on predetermined parameters, the timer message comprising fade timer information for a wireless communication device, the wireless communication device operable to set a first fade timer in the wireless communication device, the length of the first fade timer based on the fade timer information, and to provide the timer message to the wireless communication device; and
a call monitor operable to monitor a reverse channel of a call for frame quality for a plurality of frames received on the reverse channel and to reset a second fade timer in the base station based on the frame quality of the frames received on the reverse channel.

17. The base station of claim 16, the predetermined parameters comprising one or more of (i) environment, (ii) applications in use, (iii) location of the wireless communication device, (iv) previously received signals, and (v) service options.

18. The base station of claim 16, the timer message comprising one of an extended channel assignment message, a universal handoff direction message, an extended system parameter message, an origination message, a page response message, and a parameter message.

19. The base station of claim 16, the fade timer controller further operable to determine a length for the second fade timer based on predetermined parameters for the second fade timer and to set the second fade timer based on the determined length.

20. The base station of claim 19, the predetermined parameters for the second fade timer comprising a specific multiple of the length of the first fade timer.

21. The base station of claim 20, the specific multiple comprising two.

22. The base station of claim 19, the predetermined parameters for the second fade timer comprising a specific amount of time longer that the length of the first fade timer.

23. The base station of claim 16, the call monitor further operable to determine whether a specified number of the frames received most recently on the reverse channel are of good quality, to reset the second fade timer when the specified number of the frames received most recently on the reverse channel are of good quality, to determine whether the second fade timer has expired when the specified number of the frames received most recently on the reverse channel are not of good quality, and to release the call when the second fade timer has expired.

24. A wireless network, comprising:
a plurality of base stations, each base station operable to generate a timer message based on predetermined parameters, the timer message comprising fade timer information; and
a plurality of wireless communication devices, each wireless communication device comprising a fade timer, each wireless communication device operable to receive the timer message from one of the base stations, the length of the fade timer based on the fade timer information.

25. The wireless network of claim 24, the predetermined parameters comprising one or more of (i) environment, (ii) applications in use, (iii) location of the wireless communication device, (iv) previously received signals, and (v) service options.

26. The wireless network of claim 24, the timer message comprising one of an extended channel assignment message, a universal handoff direction message, an extended system parameter message, an origination message, a page response message, and a parameter message.

27. The wireless network of claim 24, the fade timer in the wireless communication device comprising a first fade timer, each base station further operable to determine a length for a second fade timer in the base station based on predetermined parameters for the second fade timer and to set the second fade timer based on the determined length.

28. The wireless network of claim 27, the predetermined parameters for the second fade timer comprising one of a specific multiple of the length of the first fade timer and a specific amount of time longer that the length of the first fade timer.
